(19) United States
(12) Patent Application Publication
(10) Pub. No.: US 2013/0257827 A1
(43) Pub. Date: Oct. 3, 2013

(54) BACKLIGHT MODULE USED IN DISPLAY DEVICE AND CONTROL METHOD OF THE SAME

(71) Applicants: Yung-Yu HSIEH, Yunlin County (TW); Jhen-Shen LIAO, Taoyuan County (TW); Hung-Hsiang CHEN, Taoyuan County (TW)

(72) Inventors: Yung-Yu HSIEH, Yunlin County (TW); Jhen-Shen LIAO, Taoyuan County (TW); Hung-Hsiang CHEN, Taoyuan County (TW)

(73) Assignee: CHUNGHWA PICTURE TUBES, LTD., Taoyuan (TW)

(21) Appl. No.: 13/570,255

(22) Filed: Aug. 9, 2012

(30) Foreign Application Priority Data
Mar. 28, 2012 (TW) 101110854

(51) Int. Cl. G09G 3/32; G06F 3/038; H05B 37/02

(52) U.S. Cl. 345/204; 315/210; 345/82

(57) ABSTRACT

A backlight module used in a display device is provided. The backlight module comprises a first and a second view-angle LED groups, a first and a second switches, a LED drive circuit for generating a drive current and a mode-control unit. The first and the second switches enable or disable the first and the second view-angle LED groups according to a first and a second PWM signals respectively. The mode-control unit operates the backlight module in 2D or 3D display mode according to a mode-control signal. In the 2D display mode, the first and the second switches enable the first and the second view-angle LED groups synchronously to emit light according to the drive current. In the 3D display mode, the first and the second switches enable the first and the second view-angle LED groups with an interlaced manner to emit light according to the drive current.

### CROSS-REFERENCE TO RELATED APPLICATIONS

This application claims priority to Taiwan Application Serial Number 101110854 filed Mar. 28, 2012, which is herein incorporated by reference.

### BACKGROUND OF THE INVENTION

1. Field of the Invention

The present disclosure relates to display technology. More particularly, the present disclosure relates to a backlight module used in a display device and a control method of the same.

2. Description of Related Art

The development of the stereoscopic display technology is able to make the observer feel that the displayed scenes and objects are realistic. Hence, the stereoscopic display technology can realize the imagination of the human. The Edi technology includes the common stereoscopic display technology that uses glasses to perceive the stereoscopic displayed frame and the auto-stereoscopic (glass-free) display technology. The common stereoscopic display technology uses the display device to display left eye images and right eye images having special information such that the left eye of the observer can perceive the left eye images and the right eye of the observer can perceive the right eye images by using the stereoscopic glasses to form the stereoscopic image. However, the common stereoscopic technology is still not popular since it is inconvenient and uncomfortable for the observer to put on the stereoscopic glasses. Hence, the auto-stereoscopic gains attention and becomes a new trend of the stereoscopic display technology.

The auto-stereoscopic technology falls largely into two categories: time-multiplexed and spatial-multiplexed. The backlight sources in the time-multiplexed technique splits the light into different directions to display the left and the right eye images in an interlaced manner such that the left eye and the right eye of the observer perceive the left eye images and the right eye images respectively. The stereoscopic display devices using the time-multiplexed technique are thus equipped with directional backlight modules. The directional backlight modules include light gratings to provide lights with different directions. However, the display devices that can operate both in the 2D (two dimensional) display mode and the 3D (three dimensional) display mode are not able to maintain its brightness under different display modes. The unequal brightness in different display modes is easy to make the observer uncomfortable. In the conventional design, complex control hardware is needed to manage the backlight module if different sources of the backlight are driven by different drive circuits respectively. Besides, in such architecture, the peak current generated during the simultaneous initialization of all the different drive circuits under the 2D display mode is larger.

Accordingly, what is needed is a backlight module used in a display device and a control method of the same to overcome the above issues.

### SUMMARY

An aspect of the present disclosure is to provide a backlight module used in a display device. The backlight module comprises a first view-angle LED group and a second view-angle LED group, a first switch and a second switch, a LED drive circuit and a mode-control unit. The first switch enables or disables the first view-angle LED group according to a first PWM (pulse width modulation) signal. The second switch enables or disables the second view-angle LED group according to a second PWM signal. The LED drive circuit generates a drive current. The mode-control unit operates the backlight module in a 2D display mode or in a 3D display mode according to a mode-control signal to generate the first PWM signal and the second PWM signal. The first switch and the second switch enable the first view-angle LED group and the second view-angle LED group synchronously according to the first PWM signal and the second PWM signal when the mode-control unit operates the backlight module in the 2D display mode according to the mode-control signal such that both of the first view-angle LED group and the second view-angle LED group emit light according to the drive current. The first switch and the second switch enable the first view-angle LED group and the second view-angle LED group with an interlaced manner according to the first PWM signal and the second PWM signal when the mode-control unit operates the backlight module in the 3D display mode according to the mode-control signal such that the first view-angle LED group or the second view-angle LED group emits light according to the drive current.

Another aspect of the present disclosure is to provide a display device. The display device comprises a backlight module and a pixel array. The backlight module comprises a first view-angle LED group and a second view-angle LED group, a first switch and a second switch, a LED drive circuit and a mode-control unit. The first switch enables or disables the first view-angle LED group according to a first PWM (pulse width modulation) signal. The second switch enables or disables the second view-angle LED group according to a second PWM signal. The LED drive circuit generates a drive current. The mode-control unit operates the backlight module in a 2D display mode or in a 3D display mode according to a mode-control signal to generate the first PWM signal and the second PWM signal. The pixel array comprises a plurality of pixels. The first switch and the second switch enable the first view-angle LED group and the second view-angle LED group synchronously according to the first PWM signal and the second PWM signal when the mode-control unit operates the backlight module in the 2D display mode according to the mode-control signal such that both of the first view-angle LED group and the second view-angle LED group emit light according to the drive current and the pixels provides a displayed frame according to the light from the first view-angle LED group and the second view-angle LED group and a display data. The first switch and the second switch enable the first view-angle LED group and the second view-angle LED group with an interlaced manner according to the first PWM signal and the second PWM signal when the mode-control unit operates the backlight module in the 3D display mode according to the mode-control signal according to the first PWM signal and the second PWM signal such that the first view-angle LED group or the second view-angle LED group emits light according to the drive current and the pixels provides a first view-angle displayed frame according to the light from the first view-angle LED group and a first display data and the pixels provides a second view-angle displayed frame according to the light from the second view-angle LED group and a second display data.

Yet another aspect of the present disclosure is to provide a backlight module control method used in a backlight module of a display device. The backlight module control method comprises the steps outlined below. Whether the backlight module is operated in a 2D display mode or in a 3D display mode is determined according to a mode-control signal. A first PWM signal and a second PWM signal are generated according to the mode-control signal. A drive current is provided and a first view-angle LED group and a second view-angle LED group connected in parallel are synchronously enabled or disabled according to the first PWM signal and the second PWM signal when the backlight module is operated in the 2D display mode according to the mode-control signal such that both of the first view-angle LED group and the second view-angle LED group emit light according to the drive current. The drive current is provided and the first view-angle LED group and the second view-angle LED group are enabled with an interlaced manner according to the first PWM signal and the second PWM signal when the backlight module is operated in the 3D display mode according to the mode-control signal such that the first vie angle LED group or the second view-angle LED group emits light according to the drive current.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a display device in an embodiment of the present disclosure;

FIG. 2 is a block diagram of the backlight module depicted in FIG. 1 in an embodiment of the present disclosure;

FIG. 3A is a timing diagram of the waveform of the display data, the first PWM signal, the second PWM signal and the backlight-enabling signal when the backlight module depicted in FIG. 2 is operated in the 20 display mode in an embodiment of the present disclosure;

FIG. 3B is a timing diagram of the waveform of the display data, the first PWM signal, the second PWM signal and the backlight-enabling signal when the backlight module depicted in FIG. 2 is operated in the 3D display mode in an embodiment of the present disclosure;

FIG. 4 is a block diagram of the backlight module depicted in FIG. 1 in another embodiment of the present disclosure;

FIG. 5A is a timing diagram of the waveform of the display data, the first PWM signal, the second PWM signal and the backlight-enabling signal when the backlight module depicted in FIG. 4 is operated in the 20 display mode in an embodiment of the present disclosure;

FIG. 5B is a timing diagram of the waveform of the display data, the first PWM signal, the second PWM signal and the backlight-enabling signal when the backlight module depicted in FIG. 4 is operated in the 3D display mode in an embodiment of the present disclosure;

FIG. 6 is a block diagram of the backlight module depicted in FIG. 1 in another embodiment of the present disclosure; and

FIG. 7 is a flow chart of a backlight module control method in an embodiment of the present disclosure.

### DESCRIPTION OF EMBODIMENTS

Reference will now be made in detail to the present embodiments of the disclosure, examples of which are illustrated in the accompanying drawings. Wherever possible, the same reference numbers are used in the drawings and the description to refer to the same or like parts.

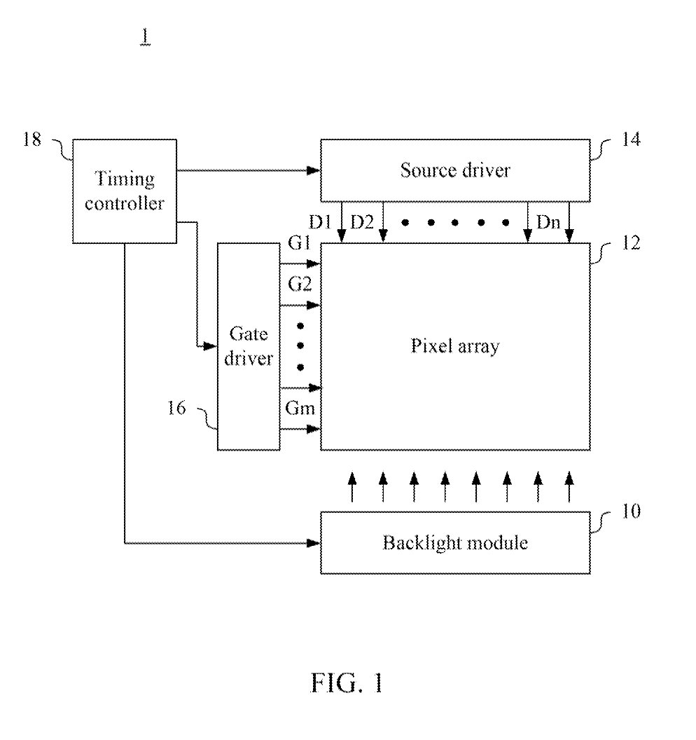

FIG. 1 is a block diagram of a display device 1 in an embodiment of the present disclosure.

The d play device 1 comprises a backlight module 10, a pixel array 12, a source driver 14, a gate driver 16 and a timing controller 18. The backlight module 10 provides a proper amount of light to the pixel array 12. The gate driver 16 transmits gate driving signals G1, G2, . . . , Gm to the pixel array 12 such that the pixels (not shown) in the pixel array 12 receive display data D1, D2, . . . , Dn provided by the source driver 14 when the gates of the pixels are turned on by the gate driving signals. The timing controller 18 further controls the backlight module 10, the source driver 14 and the gate driver 16 to manage the operation of the backlight module 10, the source driver 14 and the gate driver 16.

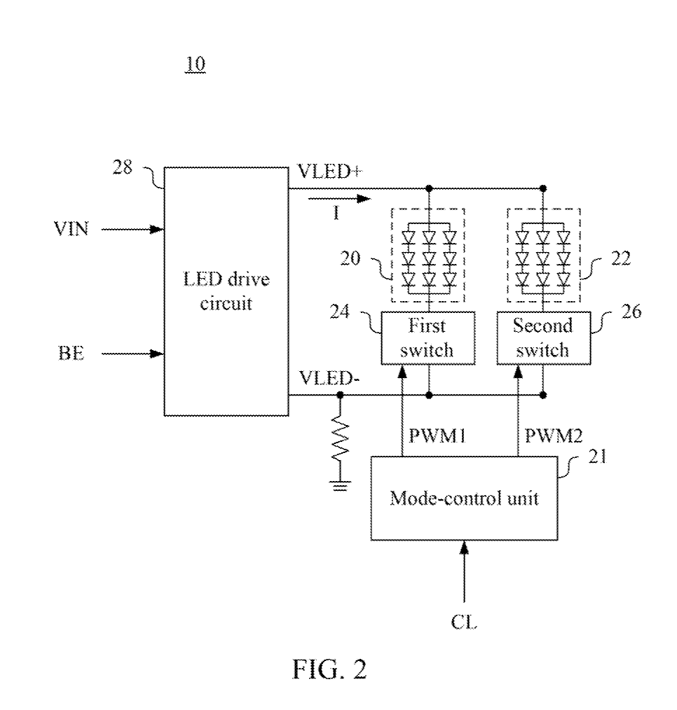

FIG. 2 is a block diagram of the backlight module 10 depicted in FIG. 1 in an embodiment of the present disclosure. The backlight module 10 comprises a first view-angle LED group 20 and a second view-angle LED group 22, a first switch 24, a second switch 26, a LED drive circuit 28 and a mode-control unit 21.

In the present embodiment, the LED drive circuit 28 is a single channel drive circuit. The first switch 24 and the second switch 26 are independently disposed outside of the LED drive circuit 28. The first switch 24 and the first view-angle LED group 20 are connected in series. The second switch 26 and the second view-angle LED group 22 are connected in series. The branch having the first switch 24 and the first view-angle LED group 20 and the branch having the second switch 26 and the second view-angle LED group 22 are further connected in parallel between a positive voltage end (VLED+) and a negative voltage end (VLED-) of the LED drive circuit 28.

The mode-control unit 21 operates the backlight module 10 in a 2D display mode or in a 3D display mode according to a mode-control signal CL. In an embodiment, the mode-control unit 21 is disposed in an image processing control unit (not shown) in the display device 1. For example, the mode-control unit 21 can be disposed in the timing controller 18 of the display device 1. In other embodiments, the mode-control unit 21 is disposed in an image processing control unit (not shown) outside of the display device 1. For example, the mode-control unit 21 can be disposed in a display card in a computer host connected to the display device 1. The mode-control unit 21 further generates the first PWM signal (PWM1) and the second PWM signal (PWM2) according to the mode-control signal CL.

The first switch 24 enables or disables the first view-angle LED group 20 according to the first PWM signal (PWM1). The second switch 26 enables or disables the second view-angle LED group according to the second PWM signal (PWM2). The LED drive circuit 28 generates a drive current I between the positive voltage end VLED+ and the negative voltage end VLED—according to a voltage signal VIN when it receives a backlight-enabling signal BE that is used to activate the LED drive circuit 28 and further transmits the drive current I to the two LED groups.

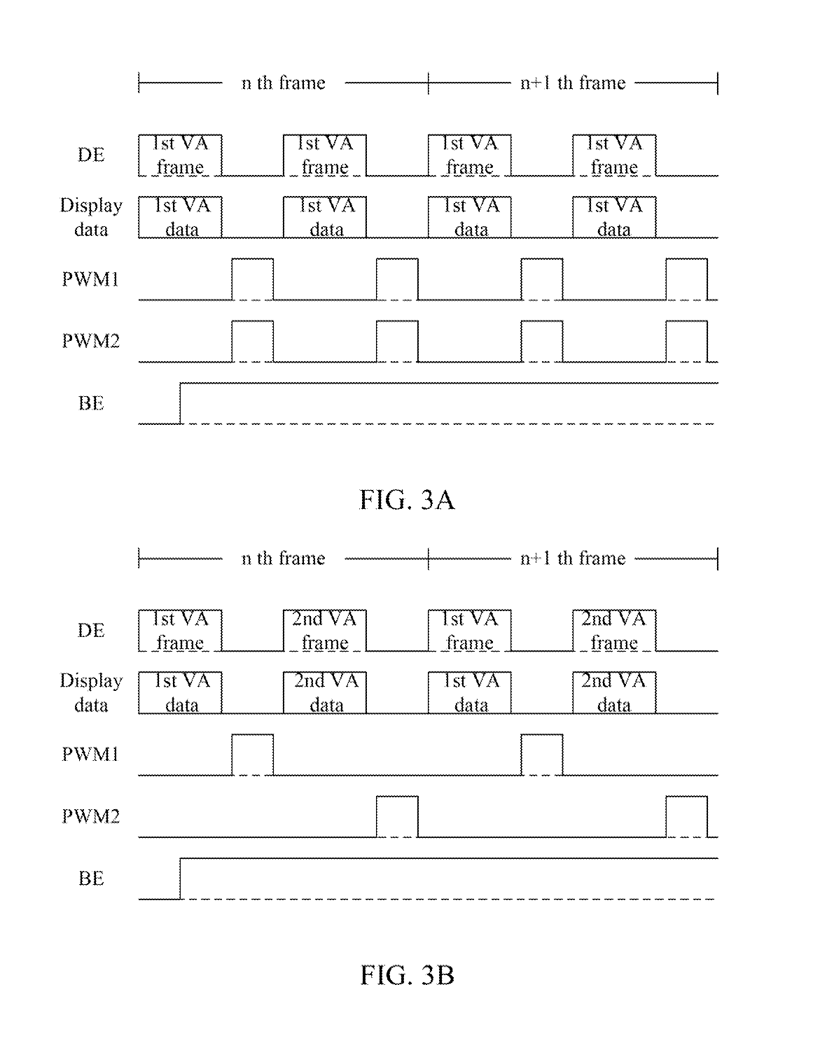

FIG. 3A is a timing diagram of the waveform of the display data, the first PWM signal (PWM1), the second PWM signal (PWM2) and the backlight-enabling signal BE of the LED drive circuit 28 when the backlight module 10 depicted in FIG. 2 is operated in the 2D display mode in an embodiment of the present disclosure. FIG. 3B is a timing diagram of the waveform of the display data, the first PWM signal (PWM1), the second PWM signal (PWM2) and the backlight-enabling signal BE of the LED drive circuit 28 when the backlight module 10 depicted in FIG. 2 is operated in the 3D display mode in an embodiment of the present disclosure.

As shown in FIG. 2 and FIG. 3A, the backlight-enabling signal BE turns from a low state to a high state under the 2D display mode to activate the LED drive circuit 28. In each of the frames (e.g. the n th frame and the n+1 th frame depicted in FIG. 3A), two parts of display data are transmitted according to the data-enabling signal DE. In the present embodiment, the two parts of the display data in the same frame are both the first view-angle display data (shown as 1st VA data in FIG. 3A). In other words, all the pixels in the pixel array 12 depicted in FIG. 1 receive the display data of the same view-angle to display the corresponding frame. Consequently, the first PWM signal (PWM1) and the second PWM signal (PWM2) turn on and turn off the first switch 24 and the second switch 26 synchronously. The first switch 24 and the second switch 26 further enable the first view-angle LED group 20 and the second view-angle LED group 22 synchronously according to the first PWM signal (PWM1) and the second PWM signal (PWM2).

Suppose that the resistive values of the first view-angle LED group 20 and the second view-angle LED group 22 are similar, the current distributed to each of the first view-angle LED group 20 and the second view-angle LED group 22 when they emit light synchronously is about the half of the drive current, i.e. ½, since the first view-angle LED group 20 and the second view-angle LED group 22 are connected in parallel. Accordingly, the pixels of the pixel array 12 provides a displayed frame according to the light from the first view-angle LED group 20 and the second view-angle LED group 22 and the display data.

As shown in FIG. 2 and FIG. 3B, the backlight-enabling signal BE turns from a low state to a high state under the 3D display mode to activate the LED drive circuit 28. In the n th frame, two parts of the display data are transmitted as well However, data of different view-angles are transmitted in different times of a single frame under the 3D display mode. Hence, the first view-angle data (shown as 1st VA data in FIG. 3B) is transmitted first and the second view-angle data (shown as 2nd VA data in FIG. 3B) is transmitted later in each of the frame. In an embodiment, the first view-angle data is the display data perceived by the left eye of the user and the second view-angle data is the display data perceived by the right eye of the user. Both of the first view-angle data and the second view-angle data are transmitted to the pixel array 12 such that the pixel array 12 can display a displayed frame according to the data.

Consequently, the first PWM signal (PWM1) and the second PWM signal (PWM2) turn on and turn off the first switch 24 and the second switch 26 with an interlaced manner. The first switch 24 and the second switch 26 further enable the first view-angle LED group 20 and the second view-angle LED group 22 with an interlaced manner according to the first PWM signal (PWM1) and the second PWM signal (PWM2). Only one of the first view-angle LED group 20 and the second view-angle LED group 22 emits light according to the drive current I. As shown in FIG. 3B, the first switch 24 turns on when the first view-angle data is received to enable the first view-angle LED group 20 such that the first view-angle LED group 20 emits light. The pixel array 12 further provides a first view-angle displayed frame according to the light of the first view-angle LED group 20 and the first view-angle display data. Further, the second switch 26 turns on when the second view-angle data is received to enable the second view-angle LED group 22 such that the second view-angle LED group 22 emits light. The pixel array 12 further provides a second view-angle displayed frame according to the light of the second view-angle LED group 22 and the second view-angle display data.

Accordingly, the first view-angle LED group 20 and the second view-angle LED group 22 of the backlight module of the present disclosure can emit light respectively and synchronously according to the half of the drive current (I/2) under the 2D display mode such that the pixel array 12 provides the displayed frame according to the light from both of the first view-angle LED group 20 and the second view-angle LED group 22. On the other hand, the first view-angle LED group 20 and the second view-angle LED group 22 of the backlight module of the present disclosure can emit light respectively with an interlaced manner according to the drive current (I) under the 3D display mode such that the pixel array 12 provides the first and the second displayed frames in turn according to the light from the first view-angle LED group 20 or the second view-angle LED group 22.

In summary, the backlight module 10 does not need to modify the width of the first PWM signal (PWM1) and the second PWM signal (PWM2) to adjust the length of the light-emitting time to maintain the brightness of the backlight. Instead, the backlight module 10 of the present disclosure can maintain the brightness of the backlight provided to the pixel array 12 under different display modes to avoid the unpleasant effect by using a single drive circuit without any additional complex control hardware. The peak current of the drive circuit generated during the initialization can also be controlled in a reasonable range.

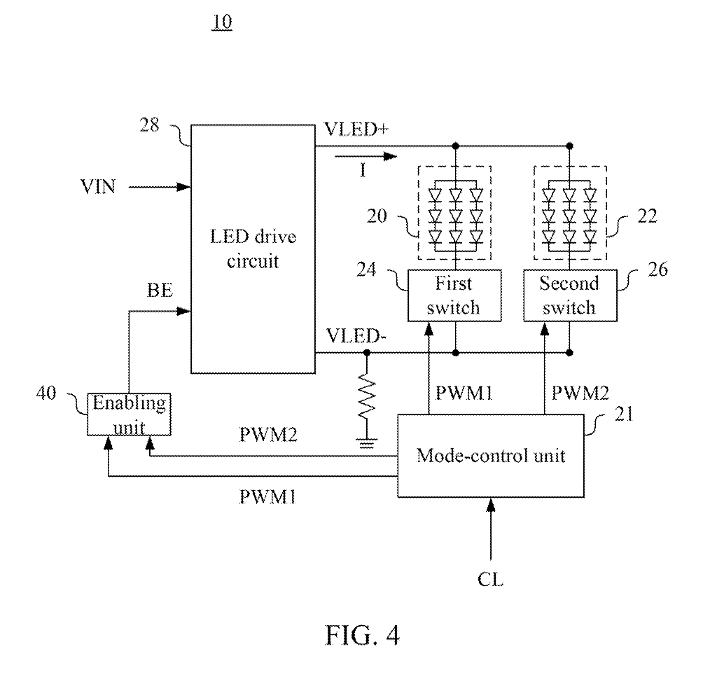

FIG. 4 is a block diagram of the backlight module 10 depicted in FIG. 1 in another embodiment of the present disclosure. The backlight module 10 depicted in FIG. 4 is similar to FIG. 2. However, the backlight module 10 in the present embodiment further comprises an enabling unit 40. The enabling unit 40 receives the first PWM signal (PWM1) and the second PWM signal (PWM2). In the present embodiment, the backlight-enabling signal. BE is generated when one of the first PWM signal (PWM1) and the second PWM signal (PWM2) is at an enabling signal level.

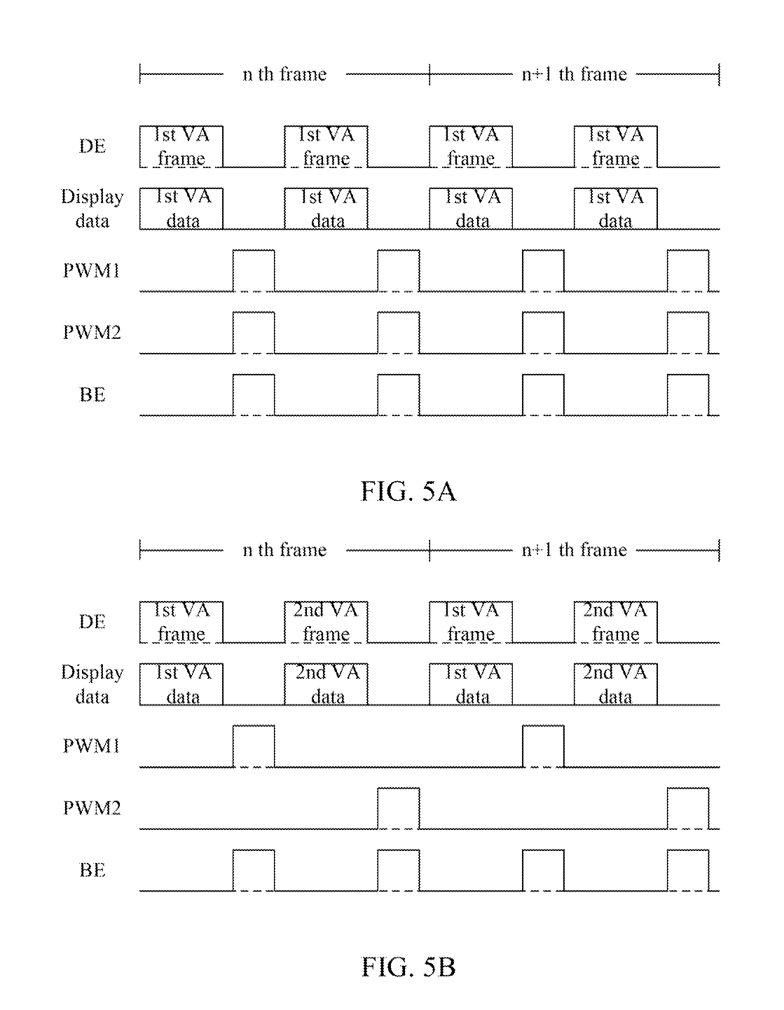

FIG. 5A is a timing diagram of the waveform of the display data, the first PWM signal (PWM1), the second PWM signal (PWM2) and the backlight-enabling signal BE of the LED drive circuit 28 when the backlight module 10 depicted in FIG. 4 is operated in the 2D display mode in an embodiment of the present disclosure. FIG. 5B is a timing diagram of the waveform of the display data, the first PWM signal (PWM1), the second PWM signal (PWM2) and the backlight-enabling signal BE of the LED drive circuit 28 when the backlight module 10 depicted in FIG. 4 is operated in the 3D display mode in an embodiment of the present disclosure.

Since the backlight-enabling signal BE is generated when one of the first. PWM signal (PWM1) and the second PWM signal (PWM2) is at the enabling signal level, the backlight-enabling signal BE in the present embodiment turns to the high state to activate the LED drive circuit 28 to provide the drive current I only when one of the first PWM signal (PWM1) and the second PWM signal (PWM2) is at the high state. When the LED drive circuit 28 detects that the LED groups is in an open-circuit state, it can activate an overvoltage protection mechanism. However, due to the characteristic of the sequential scanning of the backlight module 10, the LED groups turn on and off in the interlaced manner such that the overvoltage driven condition occurs when the LED groups turn off and results in stray power loss and lower conversion efficiency. Hence, the backlight-enabling signal BE in the present embodiment generated when one of the first PWM signal (PWM1) and the second PWM signal (PWM2) is at the enabling signal level can deactivate the LED drive circuit 28 when the LED groups turn of to avoid the activation of the overvoltage protection mechanism. In an embodiment, the enabling unit 40 can be implemented by an OR gate or other possible devices.

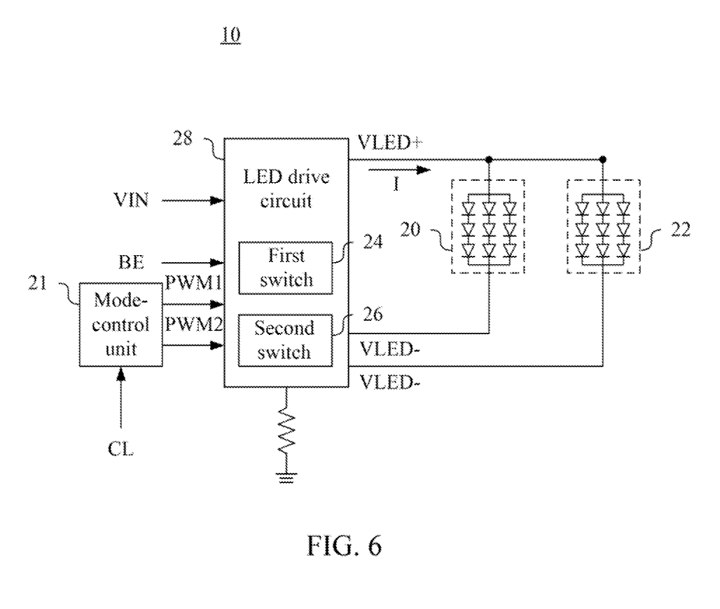

FIG. 6 is a block diagram of the backlight module 10 depicted in FIG. 1 in another embodiment of the present disclosure. The backlight module 10 depicted in FIG. 4 is similar to FIG. 2. However, the LED drive circuit 28 of the backlight module 10 in the present embodiment is a multi-channel drive circuit. The first switch 24 and the second switch 26 are disposed in the LED drive circuit 28. The first view-angle LED group 20 and the second view-angle LED group 22 are connected to the LED drive circuit 28 through different channels. The operation of the first view-angle LED group 20 and the second view-angle LED group 22 can be switched by the first switch 24 and the second switch 26 disposed in the LED drive circuit 28 according to the display modes. Therefore, the switching between the 2D display mode and the 3D display mode of the to backlight module 10 depicted in FIG. 2 can be accomplished. Further, by properly designing the circuit in the LED drive circuit 28, the backlight-enabling signal BE can be directly received to control the backlight module 10 as the operation method shown in FIG. 3A and FIG. 3B. In another embodiment, the backlight-enabling signal BE can be generated in the LED drive circuit according to first PWM signal (PWM1) and the second PWM signal (PWM2) to control the backlight module 10 as the operation method shown in FIG. 5A and FIG. 5B.

It is noted that the description of the high state and the low state of the signal is merely an example. In other embodiments, it is possible to use the low state of the signal to enable the modules and use the high state of the signal to disable the modules.

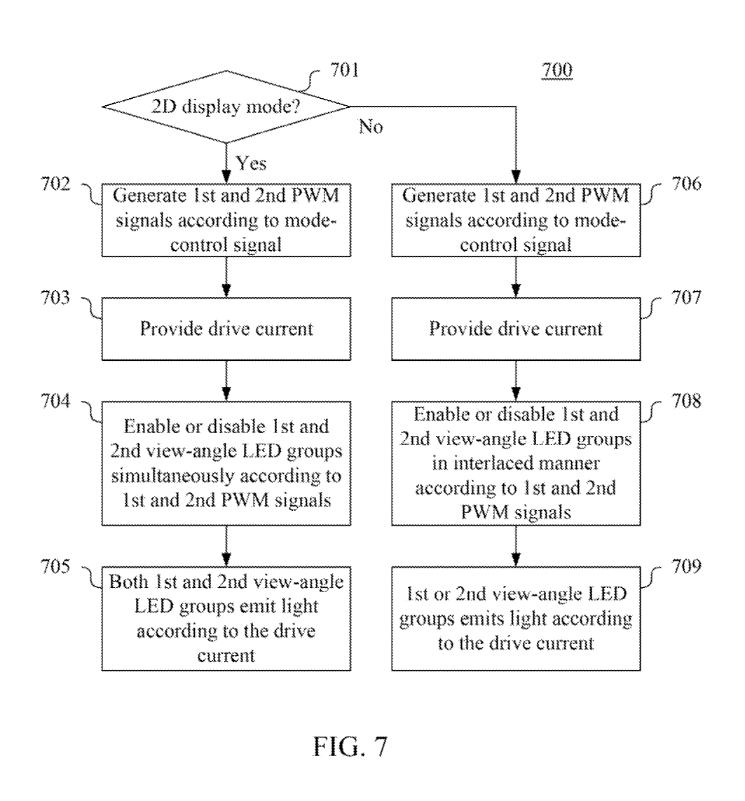

FIG. 7 is a flow chart of a backlight module control method 700 in an embodiment of the present disclosure. The backlight module control method 700 can be used in the backlight module 10 depicted in FIG. 2, FIG. 4 and FIG. 6. The backlight module control method 700 comprises the steps outlined below. The steps are not recited in the sequence in which the steps are performed. That is, unless the sequence of the steps is expressly indicated, the sequence of the steps is interchangeable, and all or part of the steps may be synchronously, partially synchronously, or sequentially performed.

In step 701, whether the backlight module 10 is operated in the 2D display mode or in the 3D display mode is determined according to the mode-control signal CL. When the backlight module 10 is operated in the 2D display mode, the first PWM signal (PWM1) and the second PWM signal (PWM2) are generated according to the mode-control signal CL in step 702 and the drive current is provided in step 703. In step 704, the first view-angle LED group 20 and the second view-angle LED group 22 connected in parallel are synchronously enabled or disabled according to the first PWM signal (PWM1) and the second PWM signal (PWM2) such that both the first view-angle LED group 20 and the second view-angle LED group 22 emit light according to the drive current in step 705.

When the backlight module 10 is not operated in the 2D display mode, it is determined that the display device 1 is operated in the 3D display mode. The first PWM signal (PWM1) and the second PWM signal (PWM2) are generated according to the mode-control signal CL in step 706 and the drive current is provided in step 707. In step 708, the first view-angle LED group 20 and the second view-angle LED group 22 are enabled or disabled with the interlaced manner according to the first PWM signal (PWM1) and the second PWM signal (PWM2) such that the first view-angle LED group 20 or the second view-angle LED group 22 emits light according to the drive current in step 709.

The LED groups of different view angles in the present disclosure can be activated synchronously under the 2D display mode and can be activated in the interlaced manner under the 3D display mode such that the brightness of the backlight provided by the backlight module can be maintained.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A backlight module used in a display device, wherein the backlight module comprises:
a first view-angle LED group;
second view-angle LED group;
a first switch for enabling or disabling the first view-angle LED group according to a first PWM (pulse width modulation) signal;
a second switch for enabling or disabling the second view-angle LED group according to a second PWM signal;
a LED drive circuit for generating a drive current; and
a mode-control unit for operating the backlight module in a 2D (two dimensional) display mode or in a 3D (three dimensional) display mode according to a mode-control signal to generate the first PWM signal and the second PWM signal;
wherein the first switch and the second switch enable the first view-angle LED group and the second view-angle LED group synchronously according to the first PWM signal and the second PWM signal when the mode-control unit operates the backlight module in the 2D display mode according to the mode-control signal, such that both of the first view-angle LED group and the second view-angle LED group emit light according to the drive current; and
wherein the first switch and the second switch enable the first view-angle LED group and the second view-angle LED group with an interlaced manner when the mode-control unit operates the backlight module in the 3D display mode according to the mode-control signal, such that the first view-angle LED group or the second view-angle LED group emits light according to the drive current.

2. The backlight module of claim 1, wherein the LED drive circuit is a single channel drive circuit and the first switch and the second switch are independently disposed outside of the LED drive circuit.

3. The backlight module of claim 1, wherein the first switch and the first vie angle LED group are connected in series and the second switch and the second view-angle LED group are connected in series.

4. The backlight module of claim 1, wherein the LED drive circuit is a multi-channel drive circuit and the first switch and the second switch are disposed inside of the LED drive circuit.

5. The backlight module of claim 1, wherein the LED drive circuit generates the drive current according to a backlight-enabling signal.

6. The backlight module of claim 5, wherein the backlight-enabling signal is generated according to the first PWM signal and the second PWM signal.

7. The backlight module of claim 6, further comprising an enabling unit to generate the backlight-enabling signal when the first PWM signal or the second PWM signal is at an enabling signal level.

8. A display device comprising:
a backlight module comprises:
a first view-angle LED group;
a second view-angle LED group;
a first switch for enabling or disabling the first view-angle LED group according to a first PWM (pulse width modulation) signal;
a second switch for enabling or disabling the second view-angle LED group according to a second PWM signal;
a LED drive circuit for generating a drive current; and
to a mode-control unit for operating the backlight module in a 2D display mode or in a 3D display mode according to a mode-control signal to generate the first PWM signal and the second PWM signal;
a pixel array comprising a plurality of pixels;
wherein the first switch and the second switch enable the first view-angle LED group and the second view-angle LED group synchronously according to the first PWM signal and the second PWM signal when the mode-control unit operates the backlight module in the 2D display mode according to the mode-control signal, such that both of the first view-angle LED group and the second view-angle LED group emit light according to the drive current and the pixels provides a displayed frame according to the light from the first view-angle LED group and the second view-angle LED group and a display data; and
wherein the first switch and the second switch enable the first view-angle LED group and the second view-angle LED group with an interlaced manner according to the first PWM signal and the second PWM signal when the mode-control unit operates the backlight module in the 3D display mode according to the mode-control signal, such that the first view-angle LED group or the second view-angle LED group emits light according to the drive current, the pixels provides a first view-angle displayed frame according to the light from the first view-angle LED group and a first display data and the pixels provides a second view-angle displayed frame according to the light from the second view-angle LED group and a second display data.

9. The display device of claim 8, wherein the LED drive circuit is a single channel drive circuit and the first switch and the second switch are independently disposed outside of the LED drive circuit.

10. The display device of claim 8, wherein the first switch and the first view-angle LED group are connected in series and the second switch and the second view-angle LED group are connected in series.

11. The display device of claim 8, wherein the LED drive circuit is a multi-channel drive circuit and the first switch and the second switch are disposed inside of the LED drive circuit.

12. The display device of claim 8, wherein the LED drive circuit generates the drive current according to a backlight-enabling signal.

13. The display device of claim 12, herein the backlight-enabling signal is generated according to the first PWM signal and the second PWM signal.

14. The display device of claim 13, further comprising an enabling unit to generate the backlight-enabling signal when the first PWM signal or the second PWM signal is at an enabling signal level.

15. A backlight module control method used in a backlight module of a display device, wherein the backlight module control method comprises:
determining whether the backlight module is operated in a 2D display mode or n a 3D display mode according to a mode-control signal;
generating a first PWM signal and a second PWM signal according to the mode-control signal;
a drive current is provided and a first view-angle LED group and a second view-angle LED group connected in parallel are synchronously enabled or disabled according to the first PWM signal and the second PWM signal when the backlight module is operated in the 2D display mode according to the mode-control signal, such that both of the first view-angle LED group and the second view-angle LED group emit light according to the drive current;
the drive current is provided and the first view-angle LED group and the second view-angle LED group are enabled with an interlaced manner according to the first PWM signal and the second PWM signal when the backlight module is operated in the 3D display mode according to the mode-control signal, such that the first view-angle LED group or the second view-angle LED group emits light according to the drive current.

16. The backlight module control method of claim 15, herein the step of generating the drive current further comprises:
generating the drive current according to a backlight-enabling signal.

17. The backlight module control method of claim 16, wherein the backlight-enabling signal is generated when the first PWM signal or the second PWM signal is at an enabling signal level.

18. The backlight module control method of claim 15, wherein when the backlight module is operated in the 2D display mode, the step of emitting light by the first view-angle LED group and the second view-angle LED group according to the drive current at the same time further comprises providing a displayed frame by a plurality of pixels of a pixel array of the display device according to the light from the first view-angle LED group and the second view-angle LED group and a display data.

19. The backlight module control method of claim 15, wherein when the backlight module is operated in the 3D display mode, the step of emitting light by one of the first view-angle LED group and the second view-angle LED group according to the drive current in a single time further comprises providing a first view-angle displayed frame by a plurality of pixels of a pixel array of the display device according to the light from the first view-angle LED group and a first display data and providing a second view-angle displayed frame by the pixels of the pixel array of the display device according to the light from the second view-angle LED group and a second display data.
